(19) United States
(12) Patent Application Publication
(10) Pub. No.: US 2008/0278508 A1
(43) Pub. Date: Nov. 13, 2008

(54) Architecture and Method for Remote Platform Control Management

(76) Inventors: Swen Anderson, Burgstadt (DE); Michael Baumann, Zwickau (DE)

Correspondence Address: GIBBONS P.C., ONE GATEWAY CENTER, NEWARK, NJ, 07102, US

(21) Appl. No.: 12/117,074

(22) Filed: May 8, 2008

Related U.S. Application Data
(60) Provisional application No. 60/917,446, filed on May 11, 2007.

(51) Int. Cl. G06F 17/00; G06K 9/36

(52) U.S. Cl. 345/519; 382/238

(57) ABSTRACT

An integrated circuit is a baseboard management controller that is a fully integrated system-on-a-chip microprocessor incorporating function blocks and interfaces that provide remote management solution. The integrated circuit uses a microprocessor, and a video compression accelerator in combination with a unified memory architecture to accelerate video processing, and a set of system and peripheral functions that are useful in a variety of remote management applications. The video compression accelerator generates hash map values for received image data, compares the hash map values to generate a difference map and encodes the image data corresponding to the difference map prior to the microprocessor sending the encoded video data to a client.

### CROSS-REFERENCE TO RELATED APPLICATION

This application claims the benefit of U.S. Provisional Application Ser. No. 60/917,446, filed May 11, 2007, the disclosure of which is incorporated herein by reference.

### FIELD OF THE INVENTION

The invention relates to an integrated circuit architecture and method for providing platform control access and management of remote devices such as servers. The inventive system on a chip combines keyboard, mouse, and video over Internet Protocol (KVM-over-IP) technology with multiple platform management access technologies.

### BACKGROUND OF THE INVENTION

The administration and management of networked servers has become increasingly more complex as file, email, Web and application servers proliferate on corporate Local Area Networks (LANs). Although these servers, unlike personnel computers, typically do not have their own keyboard, mouse and video (KVM) consoles, they still need to be configured, maintained, updated and occasionally rebooted to maintain proper operation of the LAN.

KVM systems enable a local user KVM console to remotely access and control multiple servers. Specifically, a KVM system allows the user to control a remote server using the user's local workstation's keyboard, video monitor, and mouse as if these devices were directly connected to the remote server. In this manner, the user can access and control a plurality of remote servers from a single location.

### BRIEF SUMMARY OF THE INVENTION

An integrated circuit according to the principles of the invention is a fully integrated system-on-a-chip microprocessor which incorporates function blocks and interfaces necessary to provide a complete and cost-effective remote management solution that fits all server management architectures. The integrated circuit is based on a high-performance, low-power microprocessor and is equipped with a video compression accelerator to accelerate video processing, and a comprehensive set of system and peripheral functions that are useful in a variety of remote management applications.

The microprocessor, the video compression accelerator and a unified memory architecture are used to receive, store and process video data. The video compression accelerator includes three functional components, including a hash map generator, a hash map comparator and a hash map encoder. Hextile hash maps are generated from the video data by the hash map generator as images are sent to the remote management integrated circuit. The hextile hash maps are then compared by a hash map comparator to generate a difference map. The changed hextiles are then encoded by a encoder engine and sent to a client. Multiple remote sessions can be handled by the microprocessor in cooperation with multiple versions of the functional components, such as the encoder. The unified memory architecture uses a single external memory, which is being used by the embedded microprocessor, the VGA IP core (using a fixed portion of the common memory device) and the embedded video encoder. The VGA IP core uses a video engine service request interface to allow the video encoder access to the same video memory that is used by the VGA IP core to store video data for video outputs.

The integrated circuit minimizes server downtime and increases IT productivity by enabling operating system installation, BIOS upgrade and power cycling on a server to be done remotely. In addition, since the integrated circuit is an application-specific integrated circuit (ASIC), board space and system costs are reduced. The integrated circuit supports all standardized access protocol methods in the marketplace, including Intelligent Platform Management Interface (IPMI), Secure Shell (SSH), Web Services Based Management Protocol (WS-Management) and Systems Management Architecture for Server Hardware-Command Line Protocol (SMASH-CLP). It is the manageability engine for different types of cards that support common platform interface standards, such as Open Platform Management Architecture (OPMA) and Advanced System Management Interface (ASMI).

The integrated circuit provides virtual media support that covers a broad range of mass storage emulation variations including virtual-floppy emulation, CD/DVD-drive emulation and direct mass-storage redirection. Additionally, it offers features to prevent downtime, such as health management consisting of IPMI 2.0-based server hardware monitoring. The integrated chip can provide both in-band management (communication that requires at least a functional operating system) and out-of-band management (a command and control channel such as used by terminal servers, analog KVM, KVM over IP etc).

### BRIEF DESCRIPTION OF THE DRAWINGS

In the drawings:

FIG. 1 is an exemplary functional block diagram for using the integrated chip;

FIG. 2 is an exemplary functional block diagram of the integrated chip;

FIG. 3 is an exemplary architecture and block diagram of the inventive integrated chip;

FIG. 4 is another exemplary top level block diagram of the MPCA segment of the exemplary architecture; and

FIG. 5 is a top level functional diagram of an exemplary video compression accelerator.

### DETAILED DESCRIPTION OF THE INVENTION

### 1. Use Environment and Functional Overview

In general, the invention is an integrated system-on-a-chip microprocessor for application and use in remote monitor/control systems. The invention uses a high-performance, low power microprocessor. It is equipped with a video compression accelerator to accelerate video processing and a comprehensive set of system and peripheral functions to be useful in a variety of remote monitor/control applications.

The integrated circuit may include a microprocessor with a 16 kByte data cache and a 16 kByte instruction cache, running, for example, at a clock speed of 266 MHz, and a Video Compression Accelerator (VCA) function block to accelerate video processing and compression for outstanding KVM-over-IP performance and for supporting maximum video resolutions of up to 1600×1200@75 Hz. The integrated circuit further provides an integrated USB high-speed device and an OTG interface with built-in USB-PHY to support keyboard, mouse and mass storage emulation without additional external components, and two integrated MII LAN interfaces and one FSB interface to support dedicated, as well as shared, NIC server architectures. The FSB interface may be shared with one of six I²C interfaces. It further features a flexible high-performance memory controller to support a variety of static and dynamic memory components, including serial flash components (SPI). It has an integrated AES/3DES-compliant encryption controller to ensure secure remote management sessions and IPMI2.0-compliant BMC interfaces, which include UART, Low Pin Count (“LPC”), Inter-Integrated Circuit (“I²C”, Tacho, PWM and General Purpose IO (“GPIO”) interfaces.

The integrated circuit is an application-specific structured ASIC product for peripheral interface applications. It provides the benefits of a fully verified microprocessor platform, as well as Ethernet and USB 2.0 connectivity. To support the advanced power saving functions and the control that fits industrial standard, the integrated chip provides an 8-channel ADC for measurement of specific functions. It also provides a large, flexible structured ASIC region for customer-specific functions. The common application areas for the integrated circuit include industrial automation, consumer electronics, and communication-centric devices.

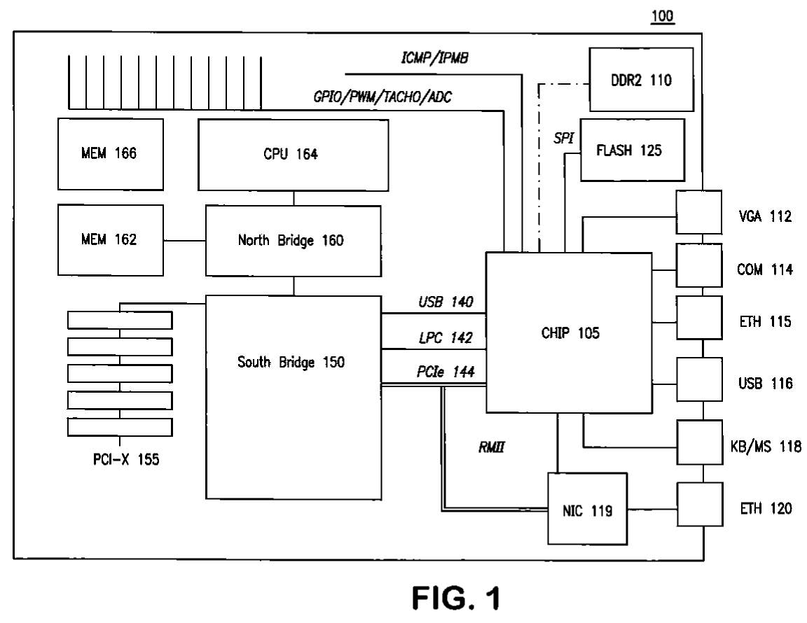

Referring now to FIG. 1, there is shown an inventive integrated circuit in a server motherboard design with the additional components needed for remote management. A server motherboard 100 includes a remote management integrated circuit or chip 105 in a northbridge/southbridge chipset computer architecture. Chip 105 communicates with external memory 110, Serial Peripheral Interface (“SPI”) Flash memory 125, core functions such as power management (PWM), error message processing (ICMP/IPMB), GPIO and multiple I/O ports such as VGA 112, COM 114, ETH 115, USB 116, and keyboard/mouse 118. Chip 105 has a further remote management interface through NIC 119 to ETH 120. Southbridge 150 communicates with Chip 105 via USB 140, LPC 142, and PCI e bus 144 and further communicates with PCI-X 155. Northbridge 160 handles communications between memory 162, memory 166, CPU 164 and southbridge 150.

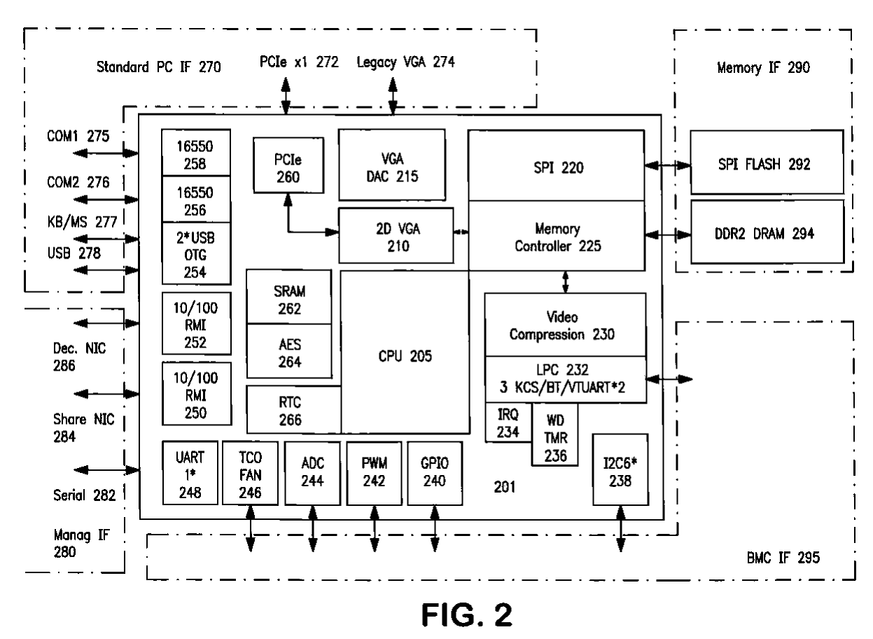

Referring now to FIG. 2, an exemplary functional block diagram of integrated chip 105 is shown. This representation shows the top level interface connections between the various top level functional sections. There is a core area 201 and four functional areas including baseband management controller interface (“BMC IF”) area 295, memory interface (“Memory IF”) area 290, standard server interface (“Standard PC IF”) area 270 and external management interface (“Manag IF”) area 280. BMC IF 295 are all the interfaces which are available for BMC applications. For example, but not limited to, BMC IF 295 is in communication with pulse width modulator 242, temperature function 246, I2C bus 238, GPIO 240 and LPC 232. Manag IF 280 are interfaces to the outer world that are necessary for getting access to the management features and include serial port 282, dedicated NIC port 286 for out-of-band communication and shared NIC port 284 for in-band communication. Standard PC IF 270 external interfaces include COM1 275, COM2, 276, keyboard/mouse 277 and USB 278. Memory IF 290 are interfaces to external memory, such as FLASH 292 and DRAM 294, which are in communications with SPI controller 220 and memory controller 225.

Core area 201 includes CPU 205 and Video Compression Accelerator (VCA) 230. VCA 230 is in communication with memory controller 225 and operates with 2D VGA Core 210, and VGA DAC 215 to process video data in accordance with the invention as discussed below. Core 201 further provides an integrated USB high-speed device and an OTG interface 254 with built-in USB-PHY to support keyboard, mouse and mass storage emulation without additional external components, all of which are in communications with Standard PC IF 270, and two integrated MII LAN interfaces 250 and 252 and one FSB interface to support dedicated, as well as shared, NIC server architectures all of which are in communications with Manag IF 280. Core area 201 has an integrated AES/3DES-compliant encryption controller 264 to ensure secure remote management sessions and IPMI2.0-compliant BMC interfaces, which include UART 248, Low Pin Count (“LPC”) 232, Inter-integrated Circuit (“I²C”) 238, Tacho, PWM 242 and General Purpose IO (“GPIO”) interfaces 240.

In a remote session, video data for an image is received and stored in DRAM 294 and accessed by CPU 205, video compression accelerator 230 and VGA 210 using memory controller 225 for processing the video data. Video compression accelerator 230 includes three functional components, including a hash map generator, a hash map comparator and a hash map encoder. Hextile hash maps are generated from the video data by the hash map generator as images are sent to the remote management integrated circuit. The hextile hash maps are then compared by a hash map comparator to generate a difference map. The changed hextiles are then encoded by an encoder engine and sent to a client.

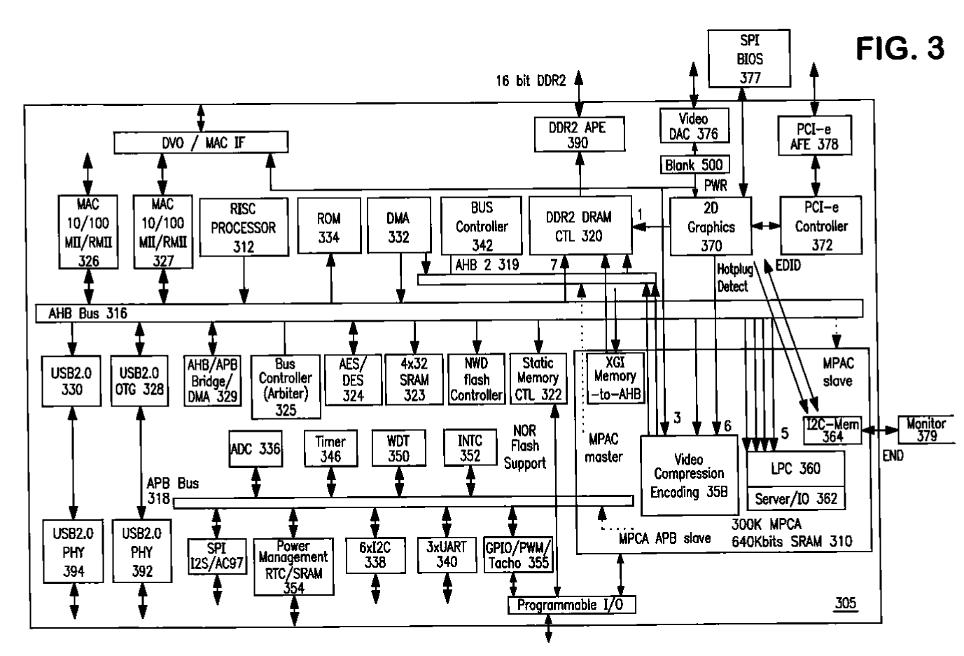

In particular, video data generated by the 2D VGA 210 is transmitted over two paths to video compression 230. The first path is a DVO connection from a DVO output of 2D VGA 210 to create a hash representation of the current video image on the fly (see for example VGA DVO interface path 3 in FIG. 3). This representation is used by video compression 230 to determine changed image content. The second path supplies actual video image content to video compression 230 for encoding. Video compression 230 then writes encoded video image date to DDR2 DRAM 294 using memory controller 225. CPU 205 packages this video data and sends it to the client using network interfaces 250 and 252 over shared NIC 284 or dedicated NIC 286. Multiple remote sessions are supported by sequentially encoding for each of the connected remote clients. Each client has its own separate hashmap in DDR2 DRAM 294 to represent the image and further new incoming images are compared to and for this particular client. This hashmap comparison may be accelerated by the integrated circuit by having multiple versions of the hashmap comparator.

### II. Integrated Chip Block Design

Referring now to FIGS. 3 and 41 a more detailed block diagram of chip 105 is discussed and shown. Integrated circuit 300 consists of two blocks: a CPU-based fixed body 305 and a Three-Metal Programmable Cell Array (3 MPCA) body 310. CPU-based fixed body 305 has been fully designed and verified to spare the users the trouble of having to develop and debug the micro-controller portion of the system. Such a CPU-based fixed body is for example a ARM9 based microcontroller chip available from several microcontroller companies like Marvell, Broadcom and others. 3 MPCA body 310 allows the users to integrate their designs to expand the specific application.

Exemplary integrated on-chip components include an embedded processor 312, a system bus 315 that is compliant with AMBA Spec. Rev 2.0 and includes an AMBA-AHB bus 316 based for high speed devices and an AMBA-APB bus 318 based for low speed devices. System bus 315 further includes a second AHB bus 319. A AHB/APB Bridge/DMA 329 connects AMBA-ABH bus 316 to AMBA-APB bus 318.

In CPU-based fixed body 305, AMBA-AHB bus 316 handles DDR2 Synchronous Dynamic Random Access Memory (SDRAM) Controller 320, Static Memory Controller (SMC) 322, AES-DES Cipher Coprocessor (AES) 324, 10/100 dual MAC Controller (MAC) 326 and 327, USB 2.0 OTG Controller with PHY (USB2.0 OTG) 328, USB 2.0 Device Controller with PHY (USBD 2.0) 330, Direct Memory Access Controller (DMAC) 332, boot ROM 334, and a 4 k×32 RAM 323. A bus controller 325 acts as an arbiter for the various components on AHB bus 316. In addition, I²C memory 364 accesses AHB bus 316.

In CPU-based fixed body 305, AMBA-APB bus 318 handles Analog-to-Digital Converter (ADC) 336, 6-channel I²C Controller (I²C) 338, 3-channel Universal Asynchronous Receiver/Transmitter (UART) 340, Internal Timer 346, Watch Dog Timer (WDT) 350, 32-channel Interrupt Controller (INTC) 352, Power & Clock Management, real-time clock and SRAM module 354, and up to 32-bit General Purpose I/O (GPIO) 356.

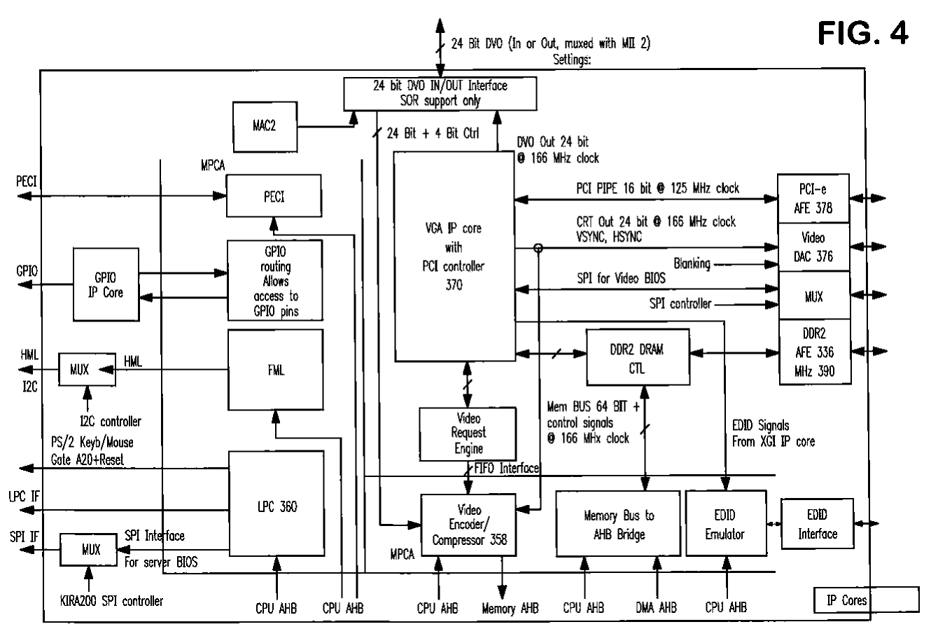

The following components are in 3 MPCA body 310: video compression encoder 358, LPC bus 360, server 110 362, and I²C Memory 364. Further details with respect to 3MPCA body 310 are shown in FIG. 4.

AHB 2 bus 319 has a bus controller 342 for controlling access from DMA 332, AHB bus 316, and DDR2 Controller 320. DDR2 Controller 320 is further coupled to DDR2 AFE 390, and to VGA 2D graphics IP core 370. With the integration of VGA 2D graphics IP core 370 and use of a shared memory architecture as illustrated below, it is not necessary to capture video data, saving considerable memory bandwidth.

VGA 2D graphics IP core 370 is further coupled to video compression encoder 358, SPI BIOS 377 and I²C memory 364 in body 310, which in turn is connected to monitor 379. VGA 2D graphics IP core 370 is still further coupled to PCI-e controller 372 and a video DAC 376. PCI-e controller 372 is also connected to PCi-e AFE (analog front end) 378.

Nominal operating characteristics for integrated chip 300 include an operating frequency of 266 MHz for CPU at commercial conditions (0° C.˜70° C., VCC+/−10%) (the CPU Clock). The clock for AMBA-AHB bus 316 is a half of CPU clock and the clock for AMBA-APB bus 318 is a half of the AMBA-AHB clock. In an exemplary embodiment, the integrated chip's speed is 333 MHz, with the CPU running at 266 MHz in synchronous mode. DDR2 Controller 320 memory interface is running at 333 MHz externally and at 366 MHz internally. AHB 316 port of DDR2 Controller 320 is running in asynchronous mode and supports 333 MHz.

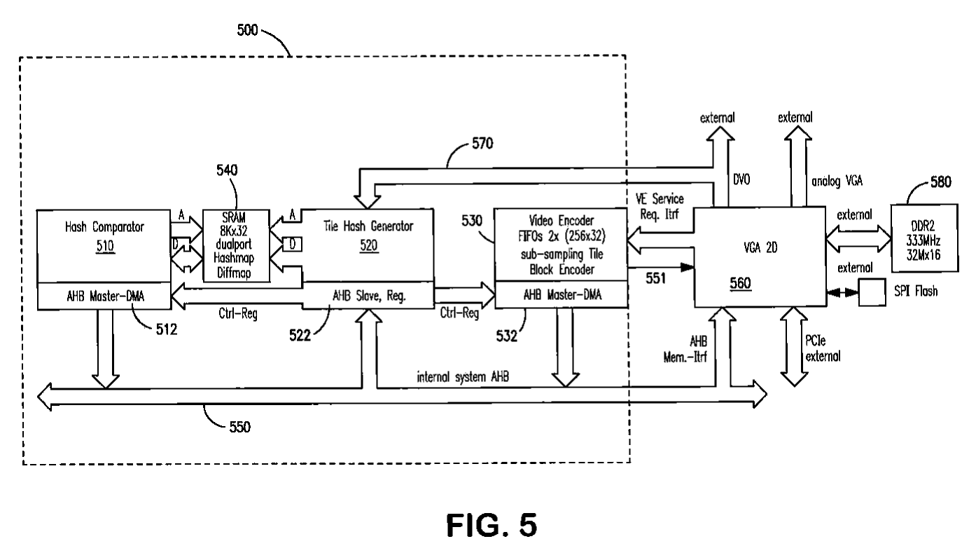

In the exemplary embodiment discussed above, DDR2 DRAM CTL 320 and DDR2 analog frontend 390 are able to access an external DDR2 memory with a 16 bit interface. The memory is shared between all components of the system except video SPI BIOS 377. All AHB masters of AHB bus 316 can access external DDR2 memory. VGA 2D graphics chip 370 uses the memory as its framebuffer. 2D VGA graphics chip 370 generates local video output via DAC 326 and sends the video image simultaneously to video compression encoder 358 for generating the hashmap. Video compression encoder 358 has a second interface (see for example interface 551 in FIG. 5) to VGA core 370 via a video request engine 410. It is used to transfer the actual video data to encode. Video compression encoder 358 will request a certain number of hextiles at specific coordinates when video data needs to be encoded for a client connected via CPU 312.

Each of the components discussed above is now described in more detail. Embedded processor 312 is a general-purpose 32-bit embedded RISC processor such as the FA526 32-bit RISC with 16 KB I-Cache/I6 KB D-Cache. It includes a CPU core, separate instruction/data caches (16K bytes each, 2-way set-associated), separate instruction/data scratchpad (16K bytes each), a write buffer (8 words for data/address each), a Memory Management Unit (MMU) and a Multi-ICE interface.

DDR2 Controller 320 supports four 8-, 16- and 32-bit-wide banks. The DDR2 Controller 320 supports an external DDR2 memory device 294 having a 512 Mbit×16 or a 256 Mbit×16 configuration.

Static Memory Controller (SMC) 322 supports flash memory, SRAM, or ROM. Each chip-select can be individually configured to an 8-, 16- or 32-bit-wide data bus. SMC 322 shares the address/data bus with SDMC 320. The SMC 322 features include zero-wait-state write, supports 8-word data FIFO, supports ROM, FLASH, burst-ROM, asynchronous SRAM, supports four (4) external banks, wide address range up to 256 M bytes and programmable/jumper set external memory bus width (8-, 16-, 32-bit).

Dual 10/100 Ethernet MAC (MAC) 326 and 327 are high quality 10/100 Ethernet controllers with DMA functions. They include an AHB wrapper, a DMA engine, on-chip memory (TX FIFO and RX FIFO), MAC, and an MII interface. MAC 326 and 327 support MII interface, RMII Interface, DMA engine for transmitting and receiving packets, programmable AHB burst size, transmit and receive interrupt mitigation mechanism, two (2) independent FIFOs (2K bytes each for TX and RX), half and full duplex modes, and flow control for full duplex and backpressure for half duplex.

USB OTG2.0 Controller (USB OTG 2.0) 328 is a universal serial bus (USB) 2.0 On-The-Go (OTG) controller, that can play a dual-role as a host and peripheral controller. The USB OTG 2.0 supports a UTMI+level2 compliant transceiver, OTG SRP and HNP, point-to point communications with on HS/FS/LS device, and embedded DMA access to FIFO. It is compatible with EHCI data structures, USB specification revision 2.0, and On-The-Go Supplement to USB2.0 specification revision 1.0. It features both host and device isochronous/interrupt/control hulk transfers and supports suspend mode, remote wake-up and resume. USB OTG 328 is further coupled to USB2.0 PHY 392.

USB 2.0 Device Controller (USBD 2.0) 330 is a universal serial bus device controller used as an interface with USB devices based on the Universal Serial Bus 2.0 specification. Controller 330 operates at a high speed signaling bit rate of 480 Mb/s and full speed signaling bit rate of 12 Mb/s. Each endpoint, except endpoint 0, can program the transfer type for isochronous, bulk, or interrupt transfer. Controller 330 is USB 1.1 compliant, USB protocol revision 2.0 full speed/high speed compatible, programmable transfer type and direction for each endpoint, four (4) (except endpoint 0) endpoints, 7K-byte FIFOs for bulk, isochronous and high-bandwidth interrupt endpoint, 2×64-byte FIFOs for non-high-bandwidth interrupt endpoint, 64-byte FIFOs for endpoint 0, and maintenance of data toggle bits. Controller 330 supports chirp sequences, isochronous, bulk, interrupt and control transfers, suspend mode, remote, wake-up and resume functions and automatic CRC5/CRC16 generation and check. Controller 330 is further coupled to USB2.0 PHY 394.

Direct Memory Access Controller (DMAC) 332 enhances system performance and reduces processor-interrupt generation. System efficiency is improved by employing high-speed data transfers between the system and device. DMAC 332 provides up to eight (8) configurable channels for memory-to-memory, memory-to-peripheral, and peripheral-to-memory transfers with the shared buffer. DMAC 332 features eight (8) DMA channels, chain transfer support, hardware handshake support, AMBA specification (rev 2.0) compliant, eight (8) DMA requests/acknowledges, memory-to-memory, memory-to-peripheral, and peripheral-to-memory transfers, and group round robin arbitration scheme with four (4) priority levels, 8-, 16- and 32-bit data width transaction.

AES-DES Cipher Coprocessor (AESC) 324 provides an efficient hardware implementation of DES and Triple DES/AES algorithms for high performance encryption and decryption which can be applied to various applications. The AESC includes block cipher mode supports, DES and Triple DES encryption/decryption compatible with NIST standard, and AES128/192/256-bit encryption/decryption compliant with NIST standard. AESC operate in multiple encryption modes. For example, 1) DES and Triple-DES operates in ECB mode, CBC mode, CFB mode and OFB mode and 2) AES operates in ECB mode, CBC mode, CFB mode, OFB mode and CTR mode, and provides a DMA function.

ADC 336 runs at a superior maximum sampling frequency rate of 200 KHz with a channel count of 4 and a 10-bit resolution capability. This results in 50 ksamples/second. It uses cyclic architecture that can be used in a wide range of high-resolution applications. A single clock input is used to control all internal conversion cycles. ADC 336 includes a maximum conversion rate of 4200 KHz, a maximum clock rate of 2.625 MHz, supports power down mode, built-in power-down mode, and eight (8) switch channels.

I²C bus interface Controller 338 is a two-wire bidirectional serial bus that provides a simple and efficient method of data exchange while minimizing the interconnection between devices. I²C bus interface Controller 338 allows the host processor to serve as a master or slave residing on I²C bus interface Controller 338. Data are transmitted to and received from I²C bus interface Controller 338 bus via a buffered interface. I²C bus interface Controller 338 supports programmable slave address, standard and fast modes through programming the clock division register, 7-bit, 10-bit and general call addressing modes, glitch suppression throughout the de-bounce circuits, Master-transmit, Master-receive, Slave-transmit and Slave-receive modes and Slave mode general call address detection All I²C pins are multiplexed with a GPIO function.

Integrated circuit 300 includes a three channel UART 340, that in general, will have two UART interfaces with complete modem control signal support and one UART interface with RXD, TXD and RTS signals only. UART 340 includes two (2) UARTs, Full Function UARTs (FFUARTs), and a Console UART. The two (2) FFUARTs use the same programming model. The FFUART supports modem control capability. The Console UART does not provide any modem control pins but includes a RTSn pin to control RS485 data direction. The UART, for example, can be a high-speed NS 16C550A-compatible UART that includes programmable baud rates up to 115.2 Kbps, capability to add or delete standard asynchronous communications bits (start, stop, and parity) in serial data and a programmable baud rate generator that allows the internal clock to be divided by 1 to (216-1) to generate an internal 16× clock. It also includes a fully programmable serial interface including i) 5-, 6-, 7-, or 8-bit characters, ii) even, odd, and no parity detection, and iii) 1, 1.5, or 2 stop bit generation. It provides complete status reporting capability, generating and detecting line breaks, fully prioritized interrupt system controls, and separate DMA requests for transmit and receive data services. It has break, parity, overrun, framing error simulation for UART mode. The FFUART provides 16-byte transmit FIFO and 16-byte receive FIFO and the STUART provides 16-byte transmit FIFO and 16-byte receive FIFO.

Timer 346 provides three (3) independent sets of timers. Each timer can use either internal system clock (PCLK) or external clock (32.768 KHz) for decrement counting. Two match registers are provided for each timer. Whenever the value of either of the match registers is equal to either of the timers, a timer interrupt is triggered immediately. When overflow occurs, whether an interrupt should be issued can be decided by register settings. The timer features include three (3) independent 32-bit timer programming models, and internal or external clock source selection. Interrupts can be issued upon overflow and time-up, and each timer has two match registers and supports decrement counting mode.

Module 354 includes a Real Time Clock (RTC) which provides a basic alarm function or long time-based counter. RTC is set to 1 Hz output and is utilized as a system timekeeper. It also serves as an alarm that generates an interrupt signal. RTC features separate second, minute, hour and day counters to reduce power consumption and software complexity, programmable daily alarm with once-per-second, once-per-minute, once-per-hour, and once-per-day interrupts and 6-bit second counter, 6-bit minute counter, 5-bit hour counter, and 16-bit day counter.

Watch Dog Timer (WDT) 350 is used to prevent the system from infinite looping if the software becomes trapped in deadlock. In normal operation, the user restarts WDT 350 at regular intervals before the counter counts down to zero. WDT 350 generates one or a combination of the following signals: reset, interrupt or external signal. WDT 350 features 32-bit down counter, access protection, output one or a combination of: system reset, system interrupt and external interrupt upon timeout, PCLK or 32.768 KHz source selection and variable timeout period of reset.

Interrupt Controller (INTC) 352 provides both FIQ and IRQ modes to the microprocessor. It also determines whether the interrupts cause an IRQ or an FIQ to occur and masks the interrupts. The INTC features up to thirty-two (32) fast interrupt (FIQ) inputs and standard interrupt (IRQ) inputs, provide both edge and level triggered interrupt source with positive and negative directions, supports de-bounce circuit for interrupt input sources, and independent interrupt source enable/disable.

GPIO module 356 includes a Pulse Width Modulator (PWM) that has eight (8) pulse width channels. They operate independently from each other, based on their own set of registers. PWM features 10-bit pulse control, eight (8) Pulse Width Modulator channels and enhanced period control through 6-bit Clock divider and 10-bit period counter.

GPIO module 356 also includes a TACHO Meter (TAM) that is used to count the number of rising edges of the external signal in a specified period. The value in the counter register of each channel can be read out for calculating the clock frequency of the external signal. Every channel has an alert flag that will be set while the clock frequency of the external signal is over or below the pre-defined boundary or counter is overflow. TAM features counter overflow check, support up to eight (8) channel measurement, and high/low alert for frequency monitor.

Power & Clock Management module 354 has frequency change control, clock gating control, normal operation, turbo mode and sleep mode. In one embodiment, integrated chip 300 has to be alive when the actual host system is powered off and therefore the total power consumption of integrated chip 300 needs to be low so it can be powered from the standby power rail. At the same time, integrated chip 300 needs to be able to detect the system power-down state. This is implemented using a system power state input. When the system is in power down, the outputs to the host must be put in Hi-Z state to prevent latch-up. This applies to the PCIe signals, the Server-IO (LPC signals and actual Tacho/GPIO/UART lines) and the video output.

Blanking the video output might be desired, but some vendors might like to display a still image during server shutdown. When the host is off the VGA PCI might be multiplexed to a PCI bridge that allows access to VGA 370 from CPU 312. Then a logo might be shown, saying “This server is off. If you want to use it please turn it on”. Access of CPU 312 by VGA 370 might be desirable for other applications as well, so the PCI switch-over is a useful feature even if customers would like their systems to blank screen if off. During the host server power off state, CPU 312 would be able to display video data on the VGA output interface and during normal server power on state, VGA core 370 would be re-opened by the host server.

LPC 362 supports LPC interface I/O read cycles and I/O write cycles. It may have three control signals, clock, reset and frame; and three register sets comprising data and status registers. It supports version 1.5 and 2.0 of the Intelligent Platform Management Interface (IPMI) and Channel 3 supports the SMIC interface, 3 KCS interfaces, and BT interface. LPC 362 supports both master and slave mode.

Chip 305 will initially boot from an internal boot ROM. The boot ROM will initialize the memory controller. This ROM code will include a basic functionality for restoring firmware on a flash. The size of this ROM will be 4 KByte. There will be a 2 bit pin strapping selecting the actual boot device as follows:

1. 00—Boot from internal ROM
2. 01—Boot from SPI Flash
3. 10—Boot from static memory 8 bits
4. 11—Boot from static memory 16 bits
When booting from internal ROM (strapping 00), a check for the SPI flash for a checksum and fallback to a failsafe update routine when it fails. Other strappings force bootup directly from external devices, so preserving the chip 100 behavior.

### III. Video Compression Accelerator

a. Overview

Referring now to FIG. 5, there is shown an architecture for a video compression accelerator (“VCA”) 500. VCA 500 consists of three main building blocks, a hash map comparator 510, a hash map generator 520 and a transfer and encoder core 530. Each of the components is discussed followed by an operational description.

Hash map comparator 510 includes a AHB Master-DMA interface 512 for communicating over a AHB bus 550 and also communicates with an internal memory, e.g. SRAM 540. Hash map comparator 510 reads a client hash backbuffer that is located in external DDR2 memory 580 and compares it with the current hash map in internal memory SRAM 540. The operation creates a diffmap (tile difference bitmap), which is also located in internal memory SRAM 540.

Hash map generator 520 includes a AHB slave interface 522 for all registers in the other two cores, hash map generator 520 and transfer and encoder core 530. Hash map generator 520 creates a map of hextile hash values in internal memory SRAM 540 for later reference.

Transfer and encoder core 530 creates requests to read pixel data which are sent to the VE Service Request Engine by interface 551 of 2D VGA Core 560. The image data is read tile by tile, encoded and sent to external DRAM memory 580 using embedded DMA 532.

In the unified memory architecture of the invention, it is not necessary to use a sampling engine to reconstruct the video image. A single external memory, such as DDR2 580, is used by chip 105 including the CPU and the VGA IP core to receive, store and process the video data. VGA IP core 560 will use a fixed portion of the common DDR2 580, e.g., 8 Mbyte in total, to store video data. Video encoder 532 also does not need dedicated DDR2 memory (like previous frame grabber based solutions did for storing captured video data). Instead, VGA IP core 560 offers a special Video Engine Service Request Interface 551 to allow video encoder 532 access to the same video memory that is also used by VGA IP core 560 to store video data for video outputs. That is, VGA IP Core 560 video memory (framebuffer) may be accessed directly. This provides encoder 530 quasi random linear access to the video memory even in text and palette modes. Not using the sampling core embodiment will save about 4 MB of memory, the area for the sampling core and the memory bandwidth consumed by the sampling core.

In the present embodiment, hardware is no longer necessary to measure the incoming image, i.e., black pixel threshold, image prescan, and image rescan error, since the image is a digital input. Data, clock and display are enabled to accurately adjust to the input frames. Further, it is also because of the digital input that it is no longer necessary to adjust phase in a phase locked loop of an analog-to-digital converter.

b. Hash Map Generator Core

Hash map generator 520 creates a hash value for each tile during image fly-by. This hash value is created during each scan and is used to obtain information about image changes and the affected screen areas. In particular, a hash value is calculated from each tile of each image sent to DVO 570. This hash value is stored as the current hash map in internal memory SRAM 540 of hash map generator 520. Since the hashing operation is done without comparing to previous frames, it is not necessary to operate two engines interleaved. A single engine can handle both initial and write-back at full frame-rate. This is possible since hash compare is delegated to a separate engine, hash comparator 510.

In one hash map processing implementation, a CRC32 polynomial is used to calculate hex-tile hashes. There is a likelihood that an image change for a tile will result in the same hash. Assuming an ideal noise source as input, every 2³² tiles should have the same hash. So every 4.3^{e9} tile sequences the hash process may fail. At 1600×1200 resolution, a single image scan contains 7500 tile sequences at 60 frames per second. So every 4.3^{e9}/(7500*60)=9544 seconds (159 minutes) a single tile sequence will not be detected statistically. This is assuming that all tiles change during each frame.

The “hash ambiguity error” results in a single tile not being updated until the next image change. So every 159 minutes of watching video a tile will be stuck for a single frame (since the image changes with every frame). The more realistic case has a much smaller “tile sequence rate”. Assuming the complete image changes every 10 seconds, the tile sequence rate is reduced by 600. The probable time until a tile will be stuck is now 95400 minutes or roughly a day. A stuck tile per day during a typical session will not be noticeable. To fix this problem (to prevent stuck tiles from being visible indefinitely when there are no more image changes) the exemplary embodiment may rescan the image with a 5 minute interval. So 25 tiles would be transferred every second even though they are not marked as being changed but only if they have not been transferred in the last 5 minutes. In another exemplary embodiment, the size of the hash may be increased to 64 bits. Then the mean interval between stuck tiles will increase to 440 million days in the worst case scenario

### Image Size Detection

Hash map generator 520 snoops DVO interface 570 and can automatically detect the video mode and provide the resolution information to hash comparator 510 and video encoder 530. The video mode information is being used internally by hash map generator 520 for proper data alignment and it is also being used by the viewer software on the remote end of a remote session.

In particular, by counting the display enable and sync signals, video mode or resolution is determined. If the resolution changes and is stable for a given number of image scans hash map generator 520 generates a “video mode change” interrupt. The detected resolution can then also be read by CPU 312 to inform the display software on the remote side of a management session about the video resolution, which uses it to display received video data in a proper way. The video mode and video resolution is also available to the other cores.

### Clock Domain Crossing

DVO interface 570 is timed by the pixel clock. To cross the clock domain from pixel clock to core clock we color reduce the pixel data to 16 bit and write it together with the control signals (sync signals and display enables) to a dual-clocked FIFO in hash map generator 520. In the core clock domain, a clock enable signal is used to mark the active phases of the video input. All measurement and hash operations use this clock enable signal. Since hash generator 520 will always process pixels at the core clock rate, the FIFO can be very small since it will only overrun if the pixel clock is higher than the core clock.

b. Hash Map Comparator

H ash map comparator 510 is started by writing the “client hash backbuffer physical address” register. The client hash backbuffer is located, for example, in DDR2 580. Hash map comparator 510 starts reading the client hash backbuffer in DDR2 580 and compares it to the recent hash map in internal memory 540. The resulting diffmap (tile difference bitmap) is also written to internal memory 540, where it can be accessed by a CPU, for example CPU 312 in FIG. 3, via AHB slave interface 522 of hash map generator 520. After the compare operation has finished, comparator 510 creates an interrupt, which is handled by an interrupt controller such as INTC 352 in FIG. 3. In an alternate embodiment, the compare operation could also be performed by CPU 312, but doing it in hardware, in the form of comparator 510, is faster. Hash map comparator 510 can operate in parallel to the hash map generator 520. Therefore internal memory SRAM 540 needs to be dual-ported.

c. Transfer/Encoder Core

Transfer and encoder core 530 reads the input framebuffer located in external memory DDR2 580 and encodes the hextiles while sending them to a FIFO as shown in encoder 530 and 532. Embedded DMA engine 532 will transfer the image data to a physical memory location in external DRAM 580. Multiple encoder cores 530 may be added to allow encoding operations to run in parallel. This allows faster video redirection speed for parallel remote sessions. With only one encoder the encoding process for multiple clients has to take place sequentially. Encoder 530 can operate in 4 modes: 1) transparent transfer (no compression); 2) Lossy Run Length Encoder (LRLE) compression, where the essence of LRLE is to encode a block of pixels as a series of runs consisting of pixels that are almost equal and is described in U.S. patent Ser. No. 11/937,867, filed Nov. 9, 2007 and entitled “Architecture and Method For Remote Platform Control Management”; 3) Downsampling or thumbnails mode, where four pixels from each scanline are merged to a single pixel (average value) and only every fourth scanline from a hextile is processed and the output are 4 by 4 pixel values for each hextile; and 4) Hex-Tile based JPEG compression as is known in the art.

In accordance with the invention, hardware based video encoder 530 gets direct access to the VGA video framebuffer memory in external memory 580 and read video data gets preformatted as hextiles (usually the video data in a VGA framebuffer is being stored linearly). In particular, 2D VGA core 560 gives direct access to the video data using X and Y coordinates. 2D VGA core 560 generates 16 bit bitmap data for palette or character mapped modes. It also includes the hardware cursor in the image data sent to encoder core 530. As shown in FIG. 4, encoder core 530 contains a prefetch engine 410 that can create addresses of hextile lines and submit requests to VE Service Request Engine 551 of 2D VGA core 560 to take advantage of the unified memory architecture. The tile data is encoded from a FIFO that accepts the pixel data bursts. Prefetch engine 410 and encoder 530 are loosely coupled and can operate almost independently from each other.

d. Operational Descriptions

Initially the client hash map backbuffer in external memory DRAM 580 is initialized with all 0. The number of client hash map backbuffers corresponds to the number of remote sessions that can run in parallel. CPU 312 can manage a certain amount of different client backbuffers, where the total number of remote sessions that can be active in parallel may be stored as a parameter.

VCA 500 reconstructs a copy of the image in the input framebuffer (in external memory 580) without CPU 312 interaction. The input framebuffer always contains the latest reconstructed image, old data will never be transferred from VCA 500. In particular, hash map generator 520 generates a hash map value for each image that is received by chip 105 and stores these hash map values in internal memory SRAM 540. When VCA 500 detects a change from the current to the next image, it can generate an interrupt. That is, video mode or resolution is determined and a “video mode change” interrupt is generated, when applicable. The CPU 312 software will then set a flag for each client handler thread that there are potential updates to transfer. In addition, the detected resolution can then be read by CPU 312 to inform the display software on the remote side of a management session about the video resolution, which uses it to display received video data in a proper way.

Hash map compare operations starts when CPU 312 detects that a client has connected. CPU 312 then starts the hash map compare operation which provides a difference map (diffmap) for this client as explained below. The diffmap is stored in SRAM 540. CPU 312 then reads the diffmap and calculates rectangular areas of changed tiles. This list of rectangles is then processed. For each rectangle and for all tiles in the current rectangle, CPU 312 needs to copy the hash map value to the client's backbuffer in DRAM 580. Alternatively, the CPU 312 software will hold a table of hextile hashes (hash map) for each client. When interrupted by VCA 500, the software compares the current hash map with each per-client hash map. If there are differences, then the client should update this region.

The diffmap is generated by using a single bit for each 16×16 pixels hextile in the video frame. Each diffmap line in memory is padded to 2048 pixels, so that each diffmap line representing a horizontal maximum of 128 hextiles is using 4 32-bit words in memory. The diffmap contains a maximum of 1200 such diffmap lines. A bit set to one (1) in the diffmap indicates that the instant hextile in the video image has changed, and a bit set to zero (0) indicates that the instant hextile is equal to the stored hextile and/or to the compared hextile.

CPU 312 can then start the encode/transfer operation and send data to the client. After all changes have been processed and all data is sent, CPU 312 can restart and calculate the difference information for this client again. When handling multiple clients the steps above are performed for each client independently. However, since there is only one hash map comparator engine, CPU 312 needs to lock the various client threads that want to perform compare operations.

Multiple virtual backbuffers (the various per-client hash maps) are used to support multiple clients with different connection speeds. When the client has requested a region for transfer, this client's hash map is updated with the contents of the current global hash map for each tile that has been transferred to the client. In accordance with this implementation, slower clients can be updated less frequent than fast ones. Moreover, finding rectangular blocks of changed tiles is performed on a per client basis and would be less frequent for slow clients. In addition, short image changes (like mouse movement) do not necessarily lead to an update of that region if the image changed back to its old contents for all clients.

While the foregoing description and drawings represent the preferred embodiments of the present invention, it will be understood that various changes and modifications may be made without departing from the spirit and scope of the present invention.

What is claimed:

1. An integrated circuit for remote management of devices, comprising:
a microprocessor;
a video compression accelerator in communication with the microprocessor to accelerate video processing of image data received from at least one of the devices and determine a changed image data from received image data;
a memory for storing received image data and encoded changed image data that is accessed by the microprocessor and the video compression accelerator; and
management and access circuitry in communications with at least the microprocessor for remote access, monitor and control of at least one of the devices,
wherein the microprocessor, video compression accelerator and management and access circuitry form a processing circuit and the memory is external to the processing circuit.

2. The integrated circuit of claim 1, wherein the video compression accelerator further comprises:
a hash map generator for generating hash map values from the received image data;
at least one hash map comparator responsive to the microprocessor for determining a difference map between the received image data and previous data; and
a hash map encoder responsive to the microprocessor for encoding changed image data corresponding to changed hash map values and writing the encoded changed image data to the memory.

3. The integrated circuit of claim 1, wherein the management and access circuitry includes integrated USB high-speed device and an OTG interface with built-in USB-PHY, integrated encryption controller to ensure secure remote management sessions, and IPMI compliant interfaces.

4. The integrated circuit of claim 1, wherein the video compression accelerator receives the received image data from memory via a first path to generate hash values and determine changed image data.

5. The integrated circuit of claim 4, wherein the video compression accelerator receives changed image data from memory via a second path to generate encoded changed image data.

6. The integrated circuit of claim 5, wherein the video compression accelerator writes encoded changed image data to the memory.

7. The integrated circuit of claim 2, wherein the video compression accelerator further comprises a plurality of hash map comparators.

8. The integrated circuit of claim 2, wherein the hash map generator stores the hash map values in internal memory and the hash map comparator compares the hash map values stored in internal memory to previous data stored in memory.

9. The integrated circuit of claim 2, wherein the video compression accelerator further comprises a plurality of hash map encoders for parallel remote sessions.

10. A circuit board, comprising:
a processing unit having a microprocessor, video accelerator and management and access circuitry;
memory for storing image data and processed image data, the memory being external to the processing unit and being accessible by the processing unit; and
the video accelerator determining changed image data from the image data in response to the microprocessor and generating processed image data from the changed image data.

11. The circuit board of claim 10, wherein the video accelerator receives the image data from memory via a first path to generate hash values and determine changed image data and the video compression accelerator receives changed image data from memory via a second path to generate encoded changed image data.

12. The circuit board of claim 10, wherein the video accelerator further comprises:
a hash map generator that generates hash map values from the image data and stores the hash map values in internal memory, the hash map generator using a first access path to the memory;
at least one hash map comparator responsive to the microprocessor for determining a difference map between the hash map values stored in internal memory and previous data stored in the memory; and
a hash map encoder responsive to the microprocessor for encoding changed image data corresponding to the difference map and writing the encoded changed image data to the memory, the hash map encoder using a second access path to the memory.

13. The circuit board of claim 12, wherein the video accelerator further comprises a plurality of hash map comparators.

14. The circuit board of claim 13, wherein the video compression accelerator further comprises a plurality of hash map encoders for parallel remote sessions.

15. A method for processing image data from a remote device, comprising the steps of:
storing received data in memory;
generating hash map values from the image data and storing in internal memory;
determining a difference map between the hash map values stored in internal memory and previous hash map values stored in memory independent from the step of generating hash map values and storing the difference map in the internal memory; and
encoding the image data stored in memory corresponding to changed hash map values in the difference map and writing encoded image data to the memory.
